(19) United States
(12) Patent Application Publication
(10) Pub. No.: US 2009/0323723 A1
(43) Pub. Date: Dec. 31, 2009

(54) Wireless communication apparatus and packet transfer method thereof

(75) Inventor: Masashi Tominaga, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/457,387

(22) Filed: Jun. 9, 2009

(30) Foreign Application Priority Data
Jun. 30, 2008 (JP) 2008-169904

(51) Int. Cl. H04L 29/02

(52) U.S. Cl. 370/474

(57) ABSTRACT

A WUSB host (or a WUSB device) transmits a combined information packet and a combined packet to the WUSB device (or the WUSB host). The combined information packet is specified with each packet length of a plurality of packets having a packet length other than a predetermined transfer unit or different packet length. The combined packet is the plurality of packets combined. At this time, the WUSB host transmits the combined information packet to a control endpoint included in the wireless USB device and transmits the combined packet to a bulk OUT endpoint. The WUSB device (or the WUSB host) divides the combined packet into the plurality of packets based on the combined information packet.

### BACKGROUND

1. Field of the Invention

The present invention relates to a wireless communication apparatus and a packet transfer method thereof, and particularly to a wireless communication apparatus and a packet transfer method thereof which are suitable for communications between a host and a device according to the wireless USB (Universal Serial Bus) standard. In the subsequent explanation, a wireless USB is referred to as a “WUSB” in order to distinguish from a USB that assumes wired connections.

2. Description of Related Art

Japanese Unexamined Patent Application Publication No. 2007-88775 (Kogure) discloses a related technique for packet transfers in a wireless communication system adopting the WUSB standard. This related technique will be described hereinafter with reference to FIG. 10.

A wireless communication system shown in FIG. 10 is composed of a PC (Personal Computer) 1, which is a host device, a host wire adapter (hereinafter sometimes referred to as an HWA) 2, which is a wireless communication apparatus connected to the PC1, a USB device 3, and a device wire adapter (hereinafter sometimes referred to as a DWA) 4, which is a wireless communication apparatus connected to the USB device 3. Wireless communications are performed between the HWA 2 and the DWA 4.

An example of the operation is described with a packet transfer from the USB device 3 to the PC 1. First, the USB device 3 receives a data transmit instruction from the PC1 via the HWA 2 and DWA 4. In response to the data transmit instruction, the USB device 3 generates data packets PD1 to PD3 to be sequentially provided to the DWA 4.

As shown in FIG. 10, assume that the data packets PD1 and PD2 have a predetermined transfer unit length, and the data packet PD3 is a short packet, whose length is less than the predetermined transfer unit length. In this case, the DWA 4 determines that the data packet PD3 is the last packet in this transfer and combines the data packets PD1 to PD3 to be transmitted to the HWA 2.

The HWA 2 divides the combined packet into the original data packets PD1 to PD3 to be sequentially provided to the PC1.

### SUMMARY

However, the inventor has found the problem in the abovementioned related technique that if data packets to be transferred include many short packets, the transfer efficiency of the data packet is reduced. This problem is described in detail with reference to FIGS. 11A and 11B.

FIG. 11A shows an operation example in the abovementioned related technique when the USB device 3 transfers the data packets PD1 to PD3, which are short packets, to the PC1. Further, FIG. 11B shows a transferring example of the data packets PD1 to PD3 from the DWA 4 to the HWA 2 together with MMC (Micro-Scheduled Management Command) packets P11 to P13 which are transferred from the HWA 2 to the DWA 4 prior to transferring the data packets PD1 to PD3. The MMC packets P11 to P13 respectively specify data phase periods (channel time) DF1 to DF3, which are transferable periods of the data packets PD1 to PD3 for the DWA 4. More specifically, each MMC packet includes control information concerning CTA (Channel Time Allocation), data transfer direction and application mode for each channel time. Namely, the MMC packet is collections of token packets. As for the operation, the DWA 4 firstly receives the data packet PD1 from the USB device 3. As the packet length of the data packet PD1 is less than the transfer unit length, the DWA 4 determines that the data packet PD1 is the last packet and transmits the data packet PD1 to the HWA 2. At this time, as shown in FIG. 11B, the DWA 4 transfers the data packet PD1 within the data phase period DF1, which is specified by the MMC packet P11 received from the HWA 2.

Next, the DWA 4 receives the data packet PD2, which is less than the transfer unit length, and transmits the data packet PD2 to the HWA 2 within the data phase period DF2, which is specified by the MMC packet P12. Lastly, the DWA 4 receives the data packet PD3, which is less than the transfer unit length, and transfers the data packet PD3 to the HWA 2 within the data phase period DF3, which is specified by the MMC packet P13.

In this way, the data packets PD1 to PD3, which are short packets, are transferred in different data phase periods from each other. As shown in FIG. 11B, there is a predetermined blank period between the data phase periods, thereby requiring more transfer time as the number of short packet increases.

Moreover, the WUSB standard defines a method described below (the method hereinafter sometimes referred to as a data burst method). In the data burst method, to one endpoint (communication buffer such as a memory or a register) included in the device wire adapter or a WUSB device which incorporates a function equivalent to the device wire adapter, data packets having a maximum packet length unit which is preliminarily specified to the one endpoint, or data packets from 512 to 3584 bytes in increments of 512 bytes are continuously transferred as one transfer unit within one data phase period. However, if any of the data packets to be transferred is a short packet, a transfer process is divided every time the short packet appears. Further, if the packet lengths of the data packets satisfy the condition of the abovementioned transfer unit but have different values (for example the packet lengths of the data packets PD1 to PD3 are 512 bytes, 1024 bytes and 1536 bytes, respectively), the transfer process is divided at each data packet. As a result, the transfer process is performed in different data phase periods by each of the division, thereby reducing the transfer efficiency of the data packets.

Especially when composing a wireless communication system using a device wire adapter, a host needs to transmit a transfer request packet for requesting a data transfer to a USB device, which is connected to the device wire adapter, and confirm a transfer result packet received in response to the transfer request packet. Many short packets are used in communications between hosts and devices. Thus the transfer request packets and transfer result packets are transmitted/received when the short packets appear which divide the transfer operations. In connection with this, a transfer direction is frequently switched (the WiMedia standard adopted by the WUSB standard as a wireless communication method requires switching time of 10 μsec). Accordingly, the transfer efficiency is further reduced. The above issue is not limited to transferring short packets but also applies when transferring data packets of different packet lengths.

Furthermore, generally the same endpoint is used for transferring the transfer request packet and the data packet. However the transfer process is divided for the transfer request packet and the data packet as the packet lengths thereof are different from each other. Therefore, the transfer request packet and the data packet are transferred in different data phase periods and not transferred in one data phase period. Specifically, as shown in FIG. 12A, upon transferring data packets PD1 to PD4 in a downlink (OUT) direction from a host to a device, a transfer request packet P51, the data packet PD1 and a transfer result packet P61, . . . , a transfer request packet P54, the data packet PD4 and a transfer result packet P64 are transferred in different data phase periods.

In a packet transfer in an uplink (IN) direction, the same endpoint is used for transferring a transfer result packet, which indicates a data obtained result from the USB device, and the data packet. Also in this case, the transfer process is divided for the transfer result packet and the data packet as the packet lengths thereof are different from each other. Therefore, the transfer request packet and the data packet are transferred in different data phase periods. Specifically, as shown in FIG. 12B, the transfer request packet P51 and the transfer result packet P61, the data packet PD1, . . . , the transfer request packet P54 and the transfer result packet P64, the data packet PD4 are transferred in different data phase periods.

Note that as another related technique, Japanese Unexamined Patent Application Publication No. 2006-243866 (Matsuda) discloses a communication method in which token packet and data packet from a host are packaged to be transmitted from a host to a device wire adapter with the aim of avoiding frequent retransmission of the same data packet. However, in the WUSB standard, the MMC packet, which packages several token packets, and the data packet are separately transferred as mentioned above. Therefore, it is difficult to apply the communication method disclosed by Matsuda to a wireless communication apparatus that carries out communications between a host and a device according to the WUSB standard.

An exemplary aspect of an embodiment of the present invention is a wireless communication apparatus that includes a combined information packet transmitter that transmits a combined information packet to another wireless communication apparatus. The combined information packet is specified with each packet length of a plurality of packets having a packet length other than a predetermined transfer unit or different packet length. The wireless communication apparatus also includes a combined packet transmitter that transmits a combined packet to the another wireless communication apparatus. The combined packet is the plurality of packets combined.

Another exemplary aspect of an embodiment of the present invention is a wireless communication apparatus that includes a combined packet receiver that receives a combined information packet and a combined packet. The combined information packet is specified with each packet length of a plurality of packets having a packet length other than a predetermined transfer unit or different packet length, and the combined packet is the plurality of packets combined. The wireless communication apparatus also includes a combined packet divider that divides the combined packet into the plurality of packets based on the combined information packet.

Another exemplary aspect of an embodiment of the present invention is a method of transferring packets that transmits a combined information packet to a wireless communication apparatus. The combined information packet is specified with each packet length of a plurality of packets having a packet length other than a predetermined transfer unit or different packet length. The method also transmits a combined packet to the wireless communication apparatus. The combined packet is the plurality of packets combined.

Another exemplary aspect of an embodiment of the present invention is a method of transferring a packet that receives a combined information packet and a combined packet. The combined information packet is specified with each packet length of a plurality of packets having a packet length other than a predetermined transfer unit or different packet length, and the combined packet is the plurality of packets combined. The method also divides the combined packet into the plurality of packets based on the combined information packet.

Namely, on the packet transmission side, short packets or packets with different packet lengths are combined and transmitted together with packet length information thereof. On the packet reception side, the packet length information is referred to, so that the combined packet is divided into the original packets. Therefore, each packet can be transferred within the same data phase period.

The present invention enables to largely reduce the packet transfer time as compared to the abovementioned related technique and data burst method, thereby improving the packet transfer efficiency between a host and a device.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a configuration example of a wireless communication apparatus according to a first exemplary embodiment of the present invention;

FIGS. 2A to 2C show an example of a data packet transfer operation in an OUT direction from a host to a device in the wireless communication apparatus according to the first exemplary embodiment of the present invention;

FIGS. 3A and 3B show an example of an effect achieved from reduced data packet transfer time in the wireless communication apparatus according to the first exemplary embodiment of the present invention;

FIG. 4 shows an example of a data packet transfer operation in an IN direction from the device to the host in the wireless communication system according to the first exemplary embodiment of the present invention;

FIG. 5 is a block diagram showing a configuration example of a wireless communication apparatus according to a second exemplary embodiment of the present invention;

FIGS. 6A to 6C show an example of a data packet transfer operation in an OUT direction from a host to a device in the wireless communication apparatus according to the second exemplary embodiment of the present invention;

FIG. 7 shows an example of a data packet transfer operation in an IN direction from the device to the host in the wireless communication system according to the second exemplary embodiment of the present invention;

FIG. 8 is a block diagram showing a configuration example of a wireless communication apparatus according to a third exemplary embodiment of the present invention;

FIG. 9 is a block diagram showing a configuration example of a wireless communication apparatus according to a fourth exemplary embodiment of the present invention;

FIG. 10 is a sequence diagram showing an example of a data packet transfer operation in a wireless communication system according to a related art;

FIGS. 11A and 11B are diagrams for explaining the problem of the related art; and

FIGS. 12A and 12B are time charts for explaining the problem of a data packet transfer operation in a wireless communication system using a device wire adapter.

### DETAILED DESCRIPTION OF THE EXEMPLARY EMBODIMENTS

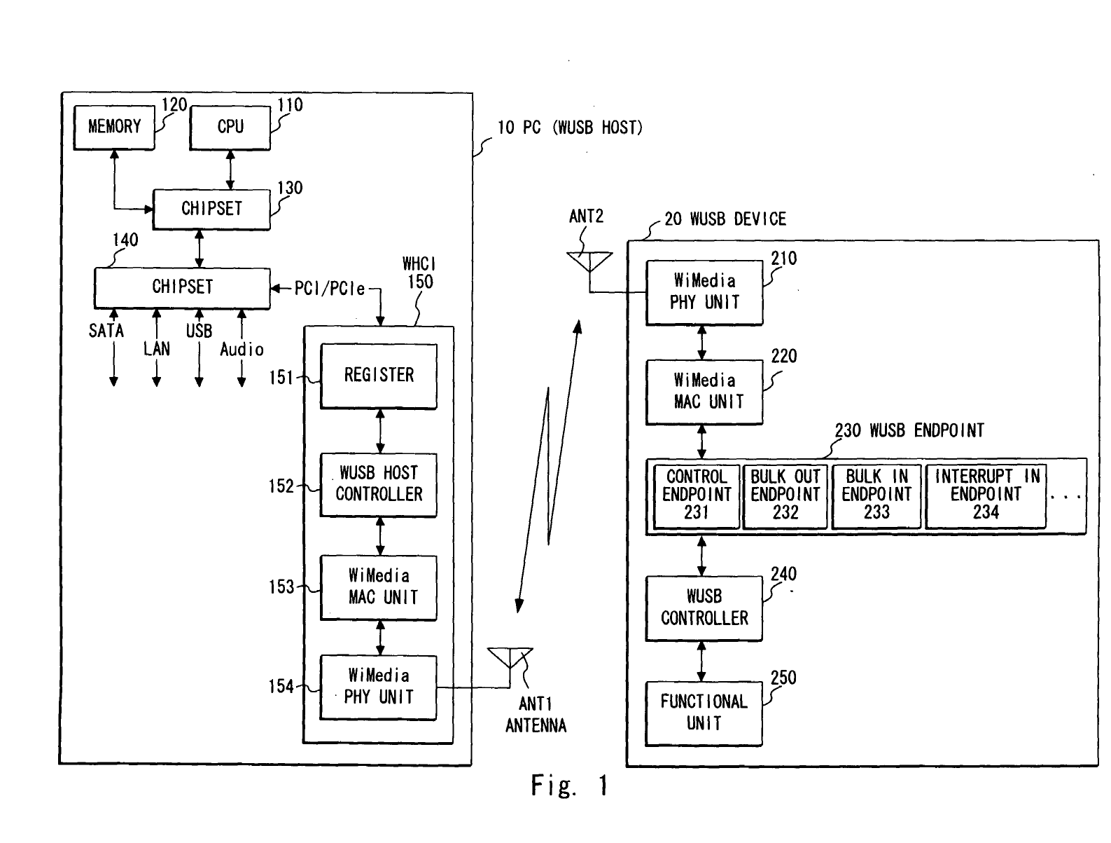

Hereafter, first to fourth exemplary embodiments of a wireless communication apparatus according to the present invention will be described with reference to FIGS. 1, 2A to 2C, 3A, 3B, 4, 5, 6A to 6C, and 7 to 9. In the drawings, components identical are denoted by reference numerals identical to those therein with duplicative description omitted as necessary for the clarity of the explanation.

### First Exemplary Embodiment

### [Configuration Example]

A wireless communication system shown in FIG. 1 is composed of a PC 10, which functions as a WUSB host, and a WUSB device 20. Wireless communications are performed between the PC 10 and the WUSB device 20.

Further, the PC 10 includes a CPU 110, a memory 120, chipsets 130 and 140, and a WHCI (Wireless Host Controller Interface) 150. The CPU 110 generates data packets to use various functions provided by the WUSB device 20. The CPU 110 executes combining process of several data packets (the packet obtained by this process is hereinafter referred to as a combined packet), a generation process of a packet specified with packet length information of each data packet (the packet hereinafter referred to as a combined information packet), and a division process of the combined packet. The memory 120 stores the data packets. The chipset 130 interconnects the CPU 110 and the memory 120. The chipset 140 is connected to the chipset 130 via a DMI (Desktop Management Interface) bus or the like, and controls peripheral devices. The WHCI 150 is connected to the chipset 140 via a PCI (Peripheral Component Interconnect) bus or a PCIe (PCI Express) bus.

The WHCI 150 includes a register 151, a WUSB host controller 152, a WiMedia MAC unit 153, and a WiMedia PHY unit 154. The register 151 is provided in order to process commands and data. The WUSB host controller 152 generates an MMC packet and transfers the combined information packet and the combined packet according to the commands from the CPU 110. The WiMedia MAC unit 153 adds a MAC header respectively to the MMC packet, the combined information packet, and the combined packet, which are outputted from the controller 152, so as to generate a frame. The MAC header is defined by the WiMedia standard. Further, the WiMedia MAC unit 153 removes a MAC header of a frame received from the WUSB device 20, so as to extract the combined information packet and the combined packet. The WiMedia PHY unit 154 converts the frame generated by the MAC unit 153 into a wireless signal to transmit via an antenna ANT1. Further, The WiMedia PHY unit 154 converts the wireless signal received via the antenna ANT1 into the frame.

Note that a device conformed to the SATA (Serial Advanced Technology Attachment) standard, a LAN (Local Area Network) device, a USB device, an audio device, and the like can be connected to the abovementioned chipset 140.

On the other hand, the WUSB device 20 includes a WiMedia PHY unit 210, a WiMedia MAC unit 220, a WUSB endpoint 230, a WUSB controller 240, and a functional unit 250. The WUSB controller 240 generates the combined information packet and the combined packet and divides the combined packet. The functional unit 250 provides various functions based on the data packet (received from the PC 10) outputted from the controller 240.

A control endpoint 231, a bulk OUT endpoint 232, a bulk IN endpoint 233, and an interrupt IN endpoint 234 are provided in the WUSB endpoint 230. The control endpoint 231 is used for transmitting and receiving the combined information packet. The bulk OUT endpoint 232 is used for receiving the combined packet from the PC 10. The bulk IN endpoint 233 is used for transmitting the combined packet to the PC 10. The interrupt IN endpoint 234 is used for periodical notification to the PC 10, such as a transfer status or the like. Note that the control endpoint 231 can be used for transmitting/receiving request commands defined in the WUSB standard or vendor-specific request commands in addition to the combined information packet. Further, the WUSB endpoint 230 may include a plurality of bulk OUT endpoints and bulk IN endpoints and an endpoint for isochronous transfer etc.

### [Operation Example]

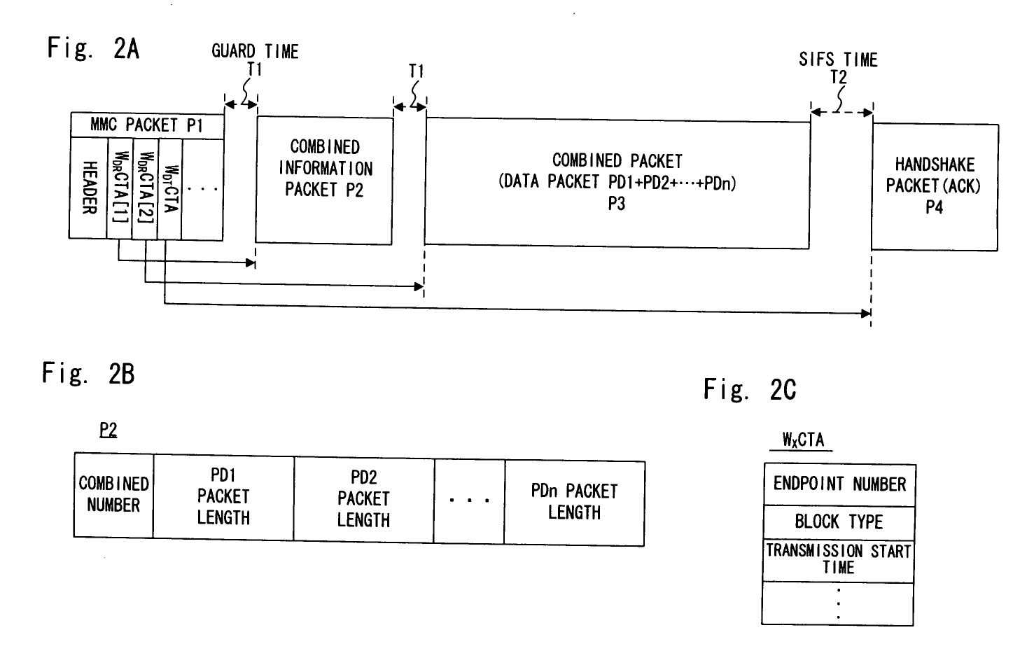

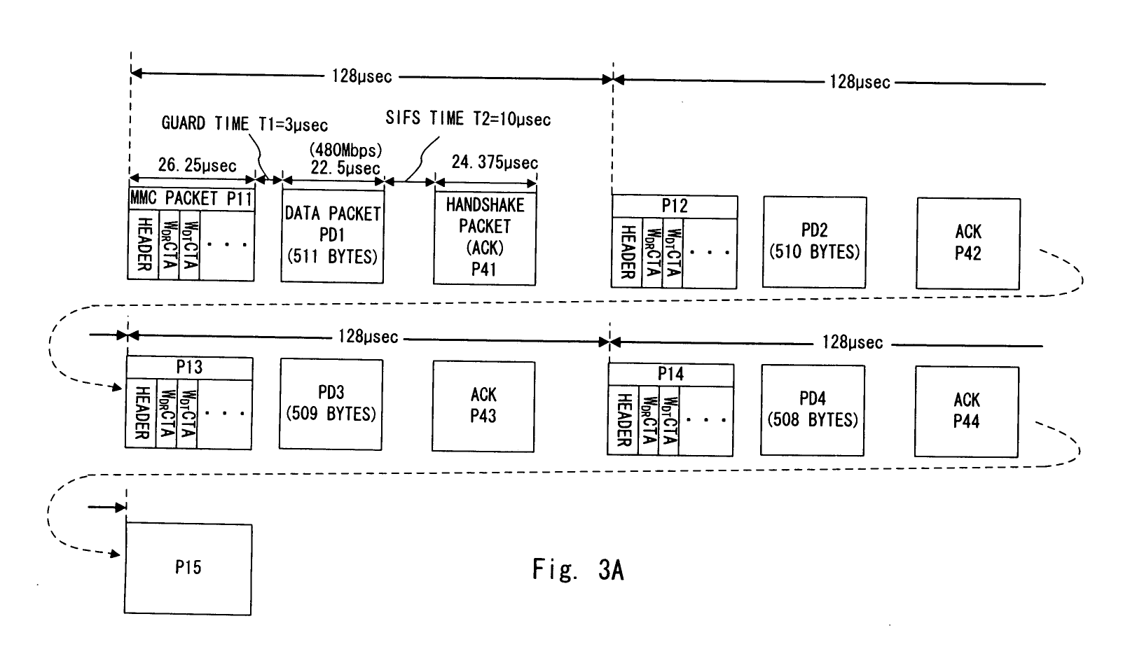

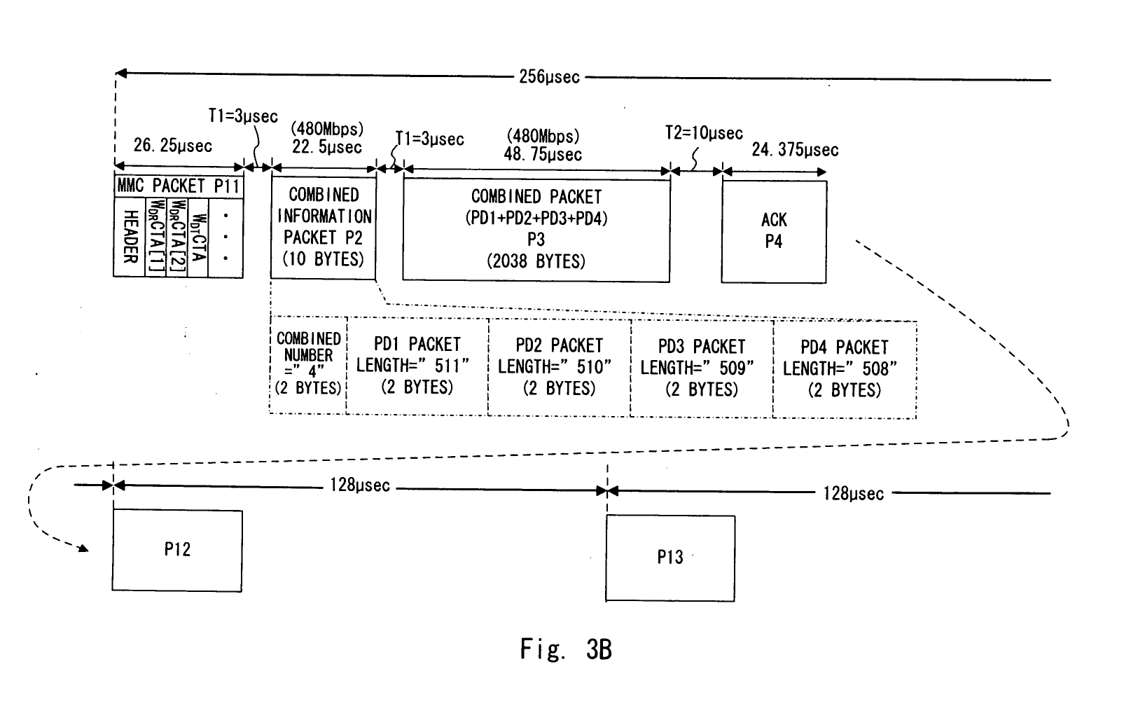

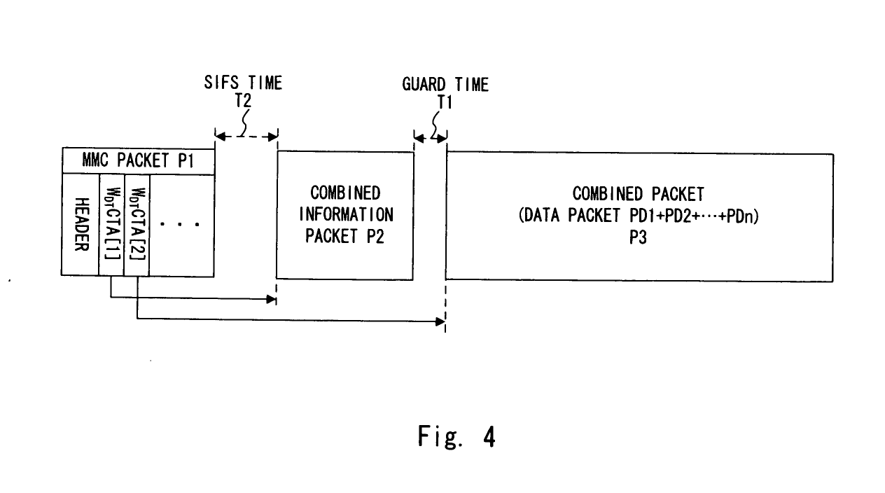

An operation of this embodiment will be explained hereinafter. Firstly, an example (1) of a data packet transfer operation in the OUT direction from the PC 10 to the WUSB device 20 is described with reference to FIGS. 2A to 2C, 3A and 3B. Then, an example (2) of a data packet transfer operation in the IN direction is described with reference to FIG. 4.

### [Data Packet Transfer Operation Example (1)]

First, the CPU 110 in the PC 10 generates a combined packet P3, which is made up of “n” number of data packets PD1 to PDn being combined as shown in FIG. 2A, and a combined information packet P2, which is specified with the combined number (=“n”) of data packets in the combined packet P3 and packet lengths of the data packets PD1 to PDn as shown in FIG. 2B. Then the CPU 110 stores the generated combined packet P3 and the combined information packet P2 in the memory 120. At this time, the CPU 110 specifies to the register 151 in the WHCI 150 a command instructing to transmit the combined information packet P2 and the combined packet P3 to the WUSB device 20. The WUSB host controller 152 recognizes that the command is specified and reads out the combined information packet P2 and the combined packet P3, which are stored in the memory 120, to the register 151 via the chipsets 130 and 140. The data packets PD1 to PDn are short packets less than transfer units defined by the WUSB standard (which are 512 bytes, 1024 bytes, 1536 bytes, 2048 bytes, 2560 bytes, 3072 bytes and 3584 bytes) or the maximum packet length preliminarily specified to the bulk OUT endpoint 232, or packets of different packet lengths.

Further, before transmitting the combined information packet P2 and the combined packet P3, the WUSB host controller 152 generates an MMC packet P1 to be provided to the WiMedia MAC unit 153. As shown in FIG. 2A, the MMC packet P1 includes an information element W_{DR}CTA[1] regarding channel time which is allocated for transmitting the combined information packet P2, an information element W_{DR}CTA[2] regarding channel time which is allocated for transmitting the combined packet P3, and an information element W_{DT}CTA regarding channel time which is allocated for receiving a handshake packet (acknowledgement ACK) from the WUSB device 20. The WiMedia MAC unit 153 adds a MAC header to the MMC packet P1. Then the WiMedia PHY unit 154 converts the MMC packet P1 into a wireless signal to be transmitted to the WUSB device 20. Note that the header in the MMC packet P1 includes transmission time of the next MMC packet, identification information indicating of the MMC packet, and the like.

The information elements W_{DR}CTA[1], W_{DR}CTA[2] and W_{DT}CTA have the format shown in FIG. 2C. The identification number of the control endpoint 231 shown in FIG. 1, the code value indicating of W_{DR}CTA, and time obtained by adding predetermined guard time T1 to transmission completion time of the MMC packet P1 are respectively specified to the endpoint number, the block type, and the transmission start time in the information element W_{DR}CTA[1]. The identification number of the bulk OUT endpoint 232, the code value indicating of W_{DR}CTA, and time obtained by adding the guard time T1 to transmission completion time of the MMC packet P2 are respectively specified to the endpoint number, the block type, and the transmission start time in the information element W_{DR}CTA[2]. Further, the identification number of the bulk OUT endpoint 232, the code value indicating of W_{DT}CTA, and time obtained by adding SIFS (Short Inter-frame Spacing) time, which is the abovementioned switching time T2 of the transfer direction, to the transmission completion time of the combined packet P3 are respectively specified to the endpoint number, the block type, and the transmission start time in the information element W_{DT}CTA.

Then, at the transmission start time specified in the information element W_{DR}CTA[1] the WUSB host controller 152 transmits the combined information packet P2 to the WUSB device 20 via the WiMedia MAC unit 153 and the WiMedia PHY unit 154. Thus in the WUSB device 20, the combined information packet P2 is stored in the control endpoint 231 via the WiMedia PHY unit 210 and the WiMedia MAC unit 220.

After that, at the transmission start time specified in the information element W_{DR}CTA[2] the WUSB controller 152 transmits the combined packet P3 to the WUSB device 20. Thus in the WUSB device 20, the combined packet P3 is stored in the bulk OUT endpoint 232.

The WUSB controller 240 in the WUSB device 20 recognizes that the combined information packet P2 and the combined packet P3 are respectively stored in the control endpoint 231 and the bulk OUT endpoint 232. Then the WUSB controller 240 refers to the combined number and each packet length, which are specified in the combined information packet P2, in order to divide the combined packet P3 into the original data packets PD1 to PDn to be provided to the functional unit 250.

Further, the WUSB controller 240 generates an ACK packet P4 to be stored in the bulk OUT endpoint 232. The WiMedia MAC unit 220 recognizes that the ACK packet is stored and then transmits the ACK packet P4 to the PC 10 via the WiMedia PHY unit 210. Thus the ACK packet P4 reaches to the CPU 110 in the PC 10. Specifically, the WUSB host controller 152 stores the ACK packet P4 in the register 151 and generates interrupt to the CPU 110, thereby completing the transfer.

In this way, short packets or packets with different packet lengths can be transferred from the PC 10 to the WUSB device 20 within the same data phase period. The bulk OUT endpoint 232 is used for transferring the combined packet P3, while the control endpoint 231 is used for transferring the combined information packet P2. Therefore, the combined information packet P2 and the combined packet P3 can be transferred within the same data phase period. Note that if there are several bulk OUT endpoints, different bulk OUT endpoints can be used for transferring the combined information packet P2 and the combined packet P3.

Accordingly, in this embodiment, the time required to transfer data packets in the OUT direction can be largely reduced as compared to the abovementioned related technique and data burst method.

To be more specific, in the abovementioned related technique and data burst method, consider an example where 4 data packets PD1 to PD4 to be transferred are short packets of 511 bytes, 510 bytes, 509 bytes, and 508 bytes respectively as shown in FIG. 3A. To transfer the data packet PD1, it takes the total time of “86.125 μsec” obtained by adding the transfer time of the MMC packet P11=“26.25 μsec”, the guard time T1=“3 μsec”, the transfer time of the data packet PD1=“22.5 μsec” (where the data packet PD1 is transferred at the maximum transmission speed in the current WUSB standard, which is “480 Mbps”), the SIFS time T2=“10 μsec”, and the transfer time of an ACK packet P41=“24.375 μsec”. The MMC packet P11 includes the information element W_{DR}CTA which is specified with the transmission start time of the data packet PD1 by the host and the information element W_{DT}CTA which is specified with the transmission start time of the ACK packet P41 by the device. Same transfer time is required for the data packets PD2 to PD4. However as described above, the data packets PD1 to PD4 are transferred in different data phase periods which are specified by the MMC packets P11 to P14. Therefore, if the transmission interval of the MMC packets is “128 μsec”, it takes “512 μsec (128 μsec×4)” to transfer the data packets PD1 to PD4.

On the other hand, in this embodiment, it takes the total time of “137.875 μsec” (>the transmission interval “128 μsec” of the MMC packet shown in FIG. 3A) to transfer the same data packets PD1 to PD4 as shown in FIG. 3B. This total time is obtained by adding the transfer time of the MMC packet P11=“26.25 μsec” (the transfer time is practically the same even with one additional information element as it has a small amount of information), the guard time T1=“3 μsec”, the transfer time of the combined information packet P2=“22.5 μsec”, the guard time T1=“3 μsec”, the transfer time of the combined packet P3 of 2038 bytes (511 bytes+510 bytes+509 bytes+508 bytes)=“48.75 μsec”, the SIFS time T2=“10 μsec”, and the transfer time of the ACK packet P41=“24.375 μsec”. The MMC packet P11 includes the information element W_{DR}CTA[1] which is specified with the transmission start time of the combined information packet P2, the information element W_{DR}CTA[2] which is specified with the transmission start time of the combined packet P3, and the information element W_{DT}CTA which is specified with the transmission start time of the ACK packet P41. In this case, it is necessary to change the transmission interval of the MMC packets to “256 μsec”. However, the transfer time of the data packets PD1 to PD4 can be reduced to “256 μsec (512 μsec−256 μsec)” as compared to FIG. 3A (in other words, the transfer efficiency can be doubled). This effect appears better as the combined number of data packets increases. Note that in this example, the combined information packet P2 is a packet of 10 bytes where the combined number “4”, and packet lengths of the data packets PD1 to PD4 “511 bytes”, “510 bytes”, “509 bytes” and “508 bytes” are respectively represented by 2 bytes.

### [Data Packet Transfer Operation Example (2)]

As for the data packet transfer operation in the IN direction, the WUSB host controller 152 in the PC 10 shown in FIG. 1 firstly generates the MMC packet P1 to be transmitted to the WUSB device 20 via the WiMedia MAC unit 153 and the WiMedia PHY unit 154. As shown in FIG. 4, the MMC packet P1 includes the information element W_{DT}CTA[1] regarding channel time allocated for receiving the combined information packet P2 from the WUSB device 20 and the information element W_{DT}CTA[2] regarding channel time allocated for receiving the combined packet P3. Note that the WUSB host controller 152 generates the MMC packet P1 by a reception of the command from the CPU 110 (command specification to the register 151) as a trigger.

The identification number of the control endpoint 231, the code value indicating of W_{DT}CTA, and time obtained by adding the SIFS T2 to the transmission completion time of the MMC packet P1 are respectively specified to the endpoint number, the block type, and the transmission start time (see FIG. 2C) in the information element W_{DT}CTA[1]. The identification number of the bulk IN endpoint 233, the code value indicating of W_{DT}CTA, and time obtained by adding the guard time T1 to the transmission completion time of the combined information packet P2 are respectively specified to the endpoint number, the block type, and the transmission start time in the information element W_{DT}CTA[2].

On the other hand, the functional unit 250 in the WUSB device 20 generates “n” number of data packets PD1 to PDn shown in FIG. 4 to be provided to the WUSB controller 240. The data packets PD1 to PDn are short packets less than the transfer units defined by the WUSB standard or the maximum packet length preliminarily specified to the bulk IN endpoint 233, or packets of different packet lengths.

Then, at the transmission start time specified by the information element W_{DT}CTA[1] the WUSB controller 240 generates the combined information packet P2, which is specified with the combined number (=“n”) of data packets PD1 to PDn and packet length of each data packets PD1 to PDn. Then the WUSB controller 240 stores the combined information packet P2 in the control endpoint 231. Thus the combined information packet P2 is transmitted to the PC 10 via the WiMedia MAC unit 220 and the WiMedia PHY unit 210.

After that, at the transmission start time specified by the information element W_{DT}CTA[2], the WUSB controller 240 generates the combined packet P3, which is combined data packets PD1 to PDn. Then the WUSB controller 240 stores the combined packet P3 in the bulk IN endpoint 233. Thus the combined packet P3 is transmitted to the PC 10.

The WUSB host controller 152 in the PC 10 receives the combined information packet P2 and the combined packet P3 to be stored in the register 151 and generates interrupt to the CPU 110. The CPU 110 refers to the combined number and packet lengths which are specified in the combined information packet P2 in order to divide the combined packet P3 into the original data packets PD1 to PDn to be sequentially processed.

In this way, short packets or packets with different packet lengths can be transferred from the WUSB device 20 to the PC 10 within the same data phase period. The bulk IN endpoint 233 is used for transferring the combined packet P3, while the control endpoint 231 is used for transferring the combined information packet P2. Therefore, the combined information packet P2 and the combined packet P3 can be transferred within the same data phase period. Note that if there are several bulk IN endpoints, different bulk IN endpoints can be used for transferring the combined information packet P2 and the combined packet P3.

Accordingly, the time required to transfer data packets in the IN direction can be largely-reduced as in the OUT direction as compared to the abovementioned related technique and data burst method.

### Second Exemplary Embodiment

### [Configuration Example]

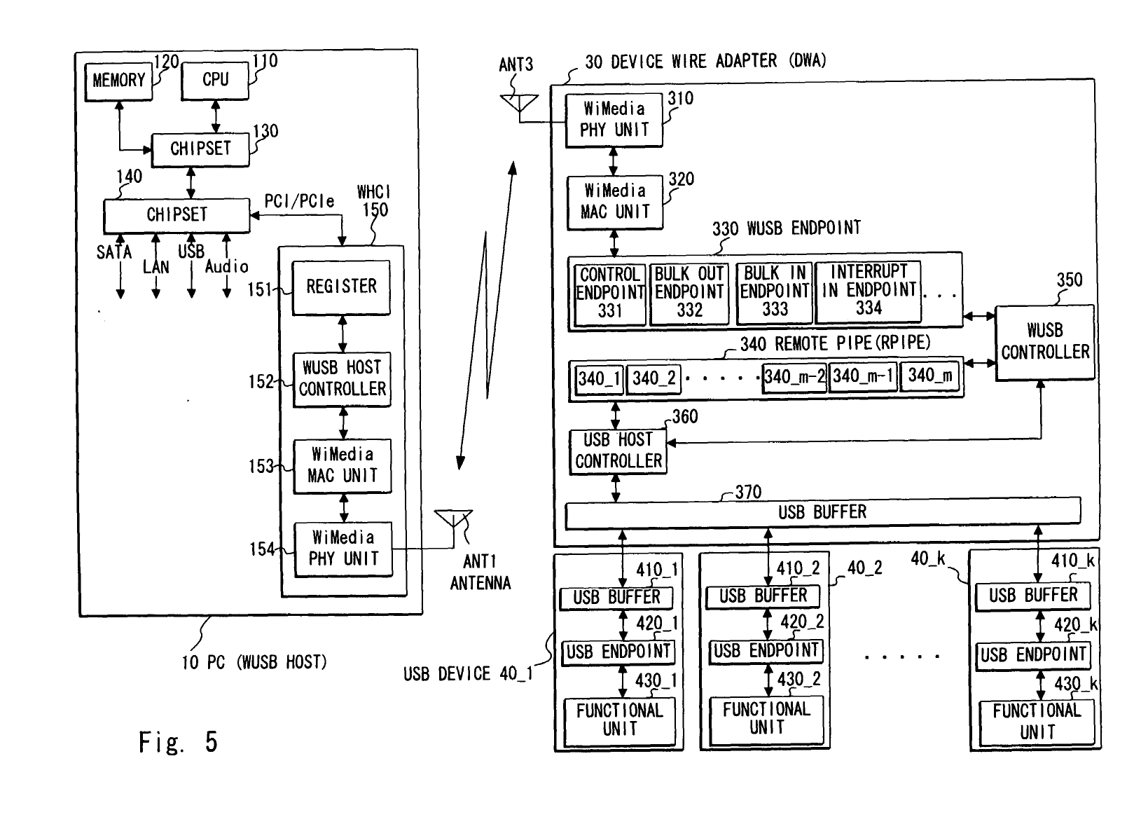

A wireless communication system shown in FIG. 5 is different from the first exemplary embodiment in that a device wire adapter (DWA) 30 and “k” number of USB devices 40_1 to 40_{—}k (hereinafter sometimes collectively referred to as the code 40) connected to the adapter 30 are used instead of the WUSB device 20 shown in FIG. 1. In this wireless communication system, wireless communications are performed between the PC 10 and the DWA 30.

The USB devices 40_1 to 40_{—}k each include USB buffers 410_1 to 410_{—}k (hereinafter sometimes collectively referred to as the code 410) provided between the DWA 30, USB endpoints 430_1 to 420_{—}k (hereinafter sometimes collectively referred to as the code 420), and functional units 430_1 to 430_{—}k (hereinafter sometimes collectively referred to as the code 430) which provide various functions to the PC 10.

Further, the DWA 30 includes a WiMedia PHY unit 310, a WiMedia MAC unit 320 and a WUSB endpoint 330 as with the WUSB device 20, and includes “m” number of remote pipes 340_1 to 340_{—}m (hereinafter referred to as RPIPE and sometimes collectively referred to as the code 340), a WUSB controller 350, a USB host controller 360, and a USB buffer 370 provided between the USB device 40. The RPIPE 340 is provided for communication with the USB endpoint 420 included in the USB device 40. The WUSB controller 350 controls reading out and writing from/to the WUSB endpoint 330 and the RPIPE 340, generates the combined information packet, and generates and divides the combined packet. The USB host controller 360 controls the USB device 40.

### [Operation Example]

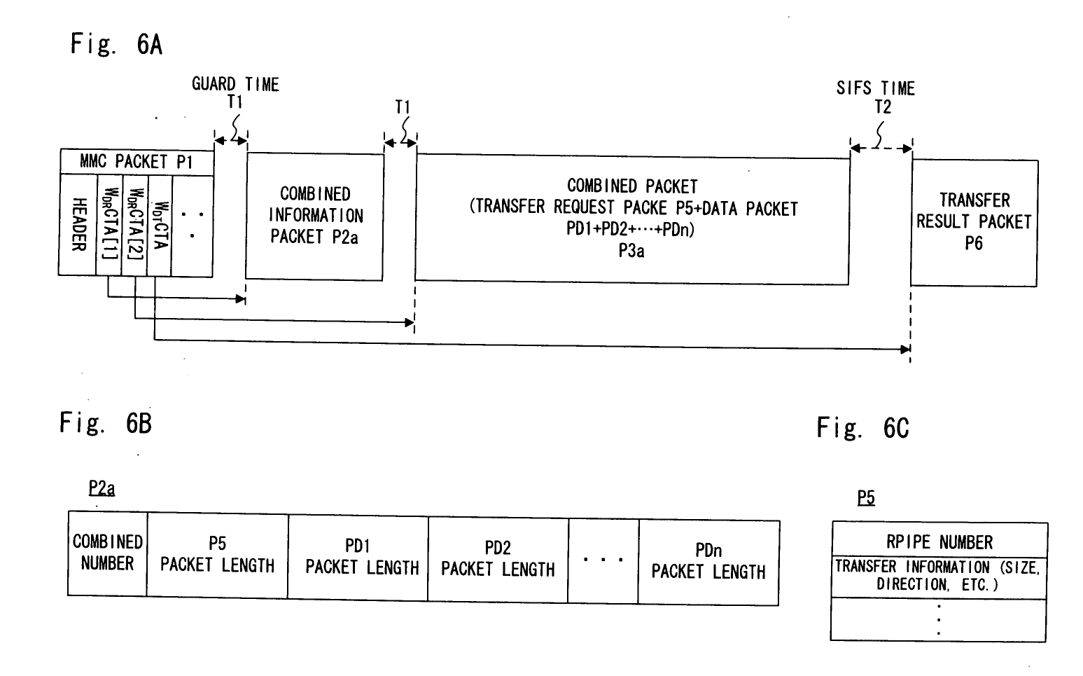

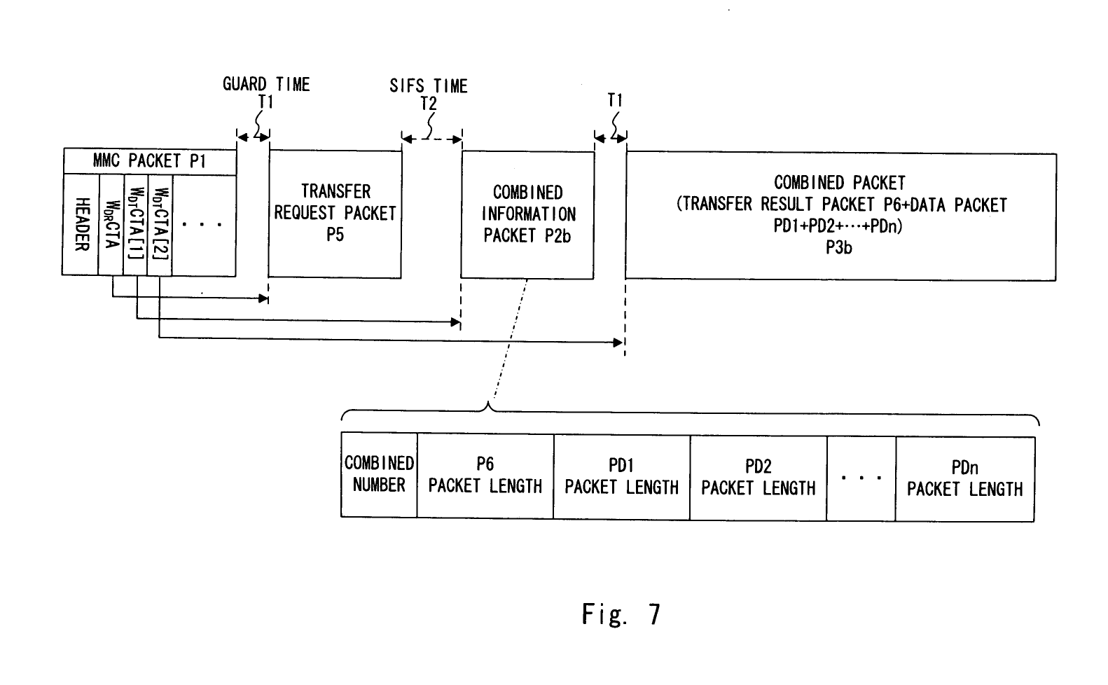

An operation of this embodiment will be explained hereinafter. Firstly, an example (1) of a data packet transfer in the OUT direction from the PC 10 to the DWA 30 is described with reference to FIGS. 6A to 6C. Then an example (2) of a data packet transfer in the IN direction is described with reference to FIG. 7.

### [Data Packet Transfer Operation Example (1)]

First, as shown in FIG. 6A, the CPU 110 in the PC 10 combines a transfer request packet P5 which requests the DWA 30 to transfer data to the USB device 40 and “n” number of data packets PD1 to PDn, thereby generating a combined packet P3a. As shown in FIG. 6B, the CPU 110 generates a combined information packet P2a, which is specified with the combined number of packets in the combined packet P3a (=transfer request packet number “1”+data packet number “n”), a packet length of the transfer request packet P5, and packet lengths of the data packets PD1 to PDn. As with the first exemplary embodiment, the CPU 110 stores the combined information packet P2a and the combined packet P3a in the memory 120. Then the WUSB controller 152 reads them out from the memory 120. The data packets PD1 to PDn are short packets less than the transfer units defined by the WUSB standard or the maximum packet length preliminarily specified to the bulk OUT endpoint 332, or packets of different packet lengths.

As shown in FIG. 6C, the identification number of the RPIPE, the size of data transferred to the RPIPE (which is the total size of the data packets PD1 to PDn), a transfer direction (the OUT direction in this example), and the like are specified in the transfer request packet P5. Note that the CPU 110 controls the WUSB host controller 152 upon executing an initialization process or the like, thereby obtaining a correspondence relationship between the identification number of the RPIPE and the USB endpoint 420 in the USB device 40.

Further, before transmitting the combined information packet P2a and the combined packet P3a, the WUSB host controller 152 generates the MMC packet P1 to be transmitted to the DWA 30 via the WiMedia MAC unit 153 and the WiMedia PHY unit 154. As shown in FIG. 6A, the MMC packet 1 includes an information element W_{DR}CTA[1] regarding channel time which is allocated for transmitting the combined information packet P2a, an information element W_{DR}CTA[2] regarding channel time which is allocated for transmitting the combined packet P3a, and an information element W_{DT}CTA regarding channel time which is allocated for receiving a transfer result packet P6 from the DWA 30.

The identification number of the control endpoint 331, the code value indicating of W_{DR}CTA, and time obtained by adding the predetermined guard time T1 to the transmission completion time of the MMC packet P1 are respectively specified to the endpoint number, the block type, and the transmission start time (see FIG. 2C) in the information element W_{DR}CTA[1]. The identification number of the bulk OUT endpoint 332, the code value indicating of W_{DR}CTA, and time obtained by adding the guard time T1 to the transmission completion time of the combined information packet P2a are respectively specified to the endpoint number, the block type, and the transmission start time in the information element W_{DR}CTA[2]. Further, the identification number of the bulk IN endpoint 333, the code value indicating of W_{DT}CTA, and time obtained by adding the SIFS time T2 to the transmission completion time of the combined packet P3a are respectively specified to the endpoint number, the block type, and the transmission start time in the information element W_{DT}CTA.

After that, at the transmission start time specified in the information element W_{DR}CTA[1], the WUSB controller 152 transmits the combined information packet P2a to the DWA 30 via the WiMedia MAC unit 153 and the WiMedia PHY unit 154. Then in the DWA 30, the combined information packet P2a is stored in the control endpoint 331 via the WiMedia PHY unit 310 and the WiMedia MAC unit 320.

At the transmission start time specified in the information element W_{DR}CTA[2], the WUSB host controller 152 transmits the combined packet P3a to the DWA 30. Thus in the DWA 30, the combined packet P3a is stored in the bulk OUT endpoint 332.

The WUSB controller 350 in the DWA 30 recognizes that the combined information packet P2a and the combined packet P3a are respectively stored in the control endpoint 331 and the bulk OUT endpoint 332. Then the WUSB controller 350 refers to the combined number and each of the packet lengths, which are specified in the combined information packet P2a, in order to divide the combined packet P3a into the original transfer request packet P5 and data packets PD1 to PDn.

At this time, the WUSB controller 350 stores the data packets PD1 to PDn in the RPIPE corresponding to the identification number specified in the transfer request packet P5 and notifies to the USB host controller 360 that the data packets are stored. The USB host controller 360 reads out the data packets PD1 to PDn from the RPIPE and provides them to the USB device 40 via the USB buffer 370.

Further, the WUSB controller 350 generates a transfer result packet P6 to be stored in the bulk IN endpoint 333. The WiMedia MAC unit 320 recognizes that the transfer result packet is stored and then transmits the transfer result packet P6 to the PC10 via the WiMedia PHY unit 310. Thus the transfer result packet P6 reaches to the CPU 110 in the PC 10.

In this way, short packets or packets with different packet lengths can be transferred together with the transfer request packet from the PC 10 to the DWA 30 within the same data phase period. The bulk OUT endpoint 332 is used for transferring the combined packet P3a, while the control endpoint 331 is used for transferring the combined information packet P2a. Therefore, the combined information packet P2a and the combined packet P3a can be transferred within the same data phase period. Note that if there are several bulk OUT endpoints, different bulk OUT endpoints can be used for transferring the combined information packet P2a and the combined packet P3a.

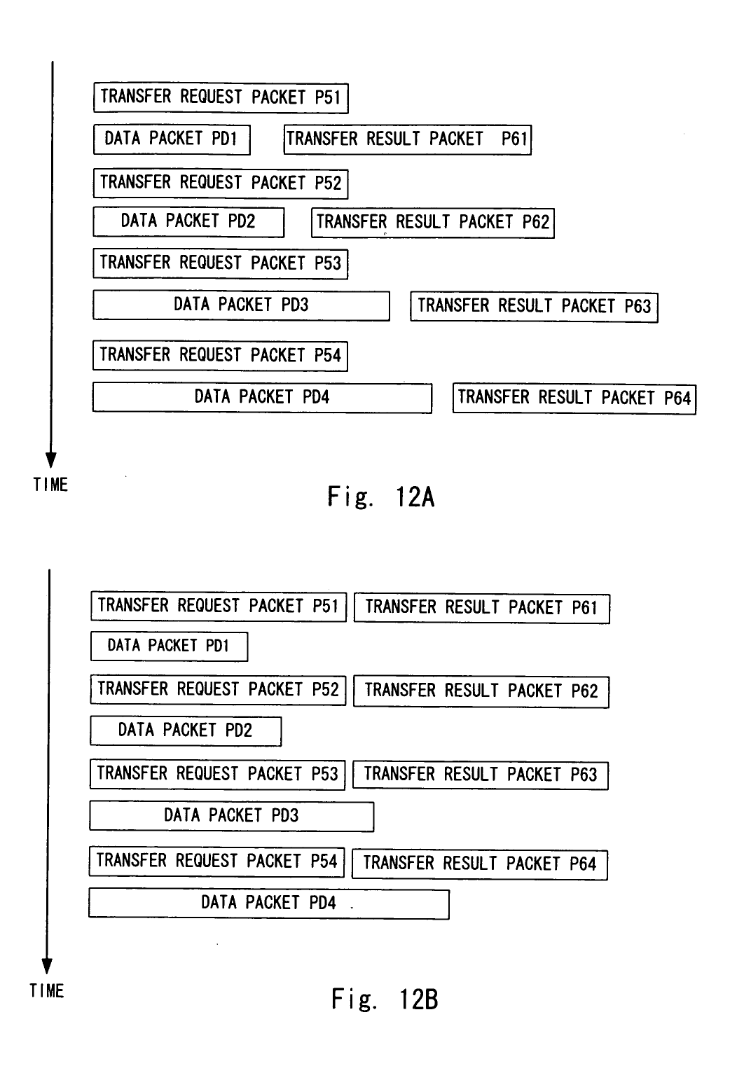

Accordingly, in this embodiment, even when composing a wireless communication system using a device wire adapter, the time required to transfer data packets in the OUT direction can be largely reduced as compared to the abovementioned related technique and data burst method (especially to FIG. 12A).

### [Data Packet Transfer Operation Example (2)]

As for the transfer data packet transfer operation in the IN direction, the CPU 110 in the PC 10 shown in FIG. 5 firstly generates the transfer request packet P5 (shown in FIG. 7) to the DWA 30. This transfer request packet P5 is once stored in the memory 120. By a reception of the command from the CPU 110 as a trigger, the WUSB host controller 152 generates the MMC packet P1 (shown in FIG. 7) to be transmitted to the DWA 30 via the WiMedia MAC unit 153 and the WiMedia PHY unit 154. The MMC packet P1 includes the information element W_{DR}CTA regarding channel time which is allocated for transmitting the transfer request packet P5, the information element W_{DT}CTA[1] regarding channel time which is allocated for receiving the combined information packet P2b from the DWA 30, and the information element W_{DT}CTA[2] regarding channel time which is allocated for receiving the combined packet P3b.

The identification number of the bulk OUT endpoint 332, the code value indicating of W_{DR}CTA, and the time obtained by adding the guard time T1 to the transmission completion time of the MMC packet P1 are respectively specified to the endpoint number, the block type, and the transmission start time (see FIG. 2C) in the information element W_{DR}CTA. The identification number of the control endpoint 331, the code value indicating of W_{DT}CTA, and the time obtained by adding the SIFS time T2 to the transmission completion time of the transfer request packet P5 are respectively specified to the endpoint number, the block type, and the transmission start time in the information element W_{DT}CTA[1]. Further, the identification number of the bulk IN endpoint 333, the code value indicating of W_{DT}CTA, and the time obtained by adding the guard time T1 to the transmission completion time of the combined information packet P2b are respectively specified to the endpoint number, the block type, and the transmission start time in the information element W_{DT}CTA[2].

At the transmission start time specified in the information element W_{DR}CTA, the WUSB host controller 152 transmits the transfer request packet P5, which is read out from the memory 120, to the DWA 30.

The USB host controller 360 in the DWA 30 receives the transfer request packet P5, obtains “n” number of data packets PD1 to PDn shown in FIG. 7 from the USB device 40, and stores them in the RPIPE 340 as well as notifying the obtained result of the data packets to the WUSB controller 350. The data packets PD1 to PDn are short packets less than the transfer units defined by the WUSB standard or the maximum packet length preliminarily specified to the bulk IN endpoint 333, or packets of different packet lengths.

The WUSB controller 350 combines the data packets PD1 to PDn read out from the RPIPE 340, and the transfer result packet P6 which is specified with the obtained result of the data packets notified from the USB host controller 360, thereby generating the combined packet P3b. Further, as shown in FIG. 7, the WUSB controller 350 generates the combined information packet P2b, which is specified with the combined packet number in the combined packet P3b (=transfer result packet number “1”+data packet number “n”), a packet length of the transfer result packet P6, and packet lengths of the data packets PD1 to PDn.

At the transmission start time specified by the information element W_{DT}CTA[1], the WUSB controller 350 stores the combined information packet P2b in the control endpoint 331. Thus the combined information packet P2b is transmitted to the PC 10 via the WiMedia MAC unit 320 and the WiMedia PHY unit 310.

After that, at the transmission start time specified by the information element W_{DT}CTA[2], the WUSB controller 350 stores the combined packet P3b in the bulk IN endpoint 333. Thus the combined packet P3b is transmitted to the PC 10.

The WUSB host controller 152 in the PC 10 receives the combined information packet P2b and the combined packet P3b to be stored in the register 151 and generates interrupt to the CPU 110. The CPU 110 refers to the combined number and the packet lengths which are specified in the combined information packet P2b in order to divide the combined packet P3b into the original transfer result packet P6 and data packets PD1 to PDn to be sequentially processed.

In this way, short packets or packets with different packet lengths can be transferred together with the transfer result packet from the DWA 30 to the PC 10 within the same data phase period. The bulk IN endpoint 333 is used for transferring the combined packet P3b, while the control endpoint 331 is used for transferring the combined information packet P2b. Therefore, the combined information packet P2b and the combined packet P3b can be transferred within the same data phase period. Note that if there are several bulk IN endpoints, different bulk IN endpoints can be used for transferring the combined information packet P2b and the combined packet P3b.

Accordingly, even when composing a wireless communication system using a device wire adapter, the time required to transfer data packets in the IN direction can be largely reduced as in the OUT direction as compared to the abovementioned related technique and data burst method (especially to FIG. 12B).

### Third Exemplary Embodiment

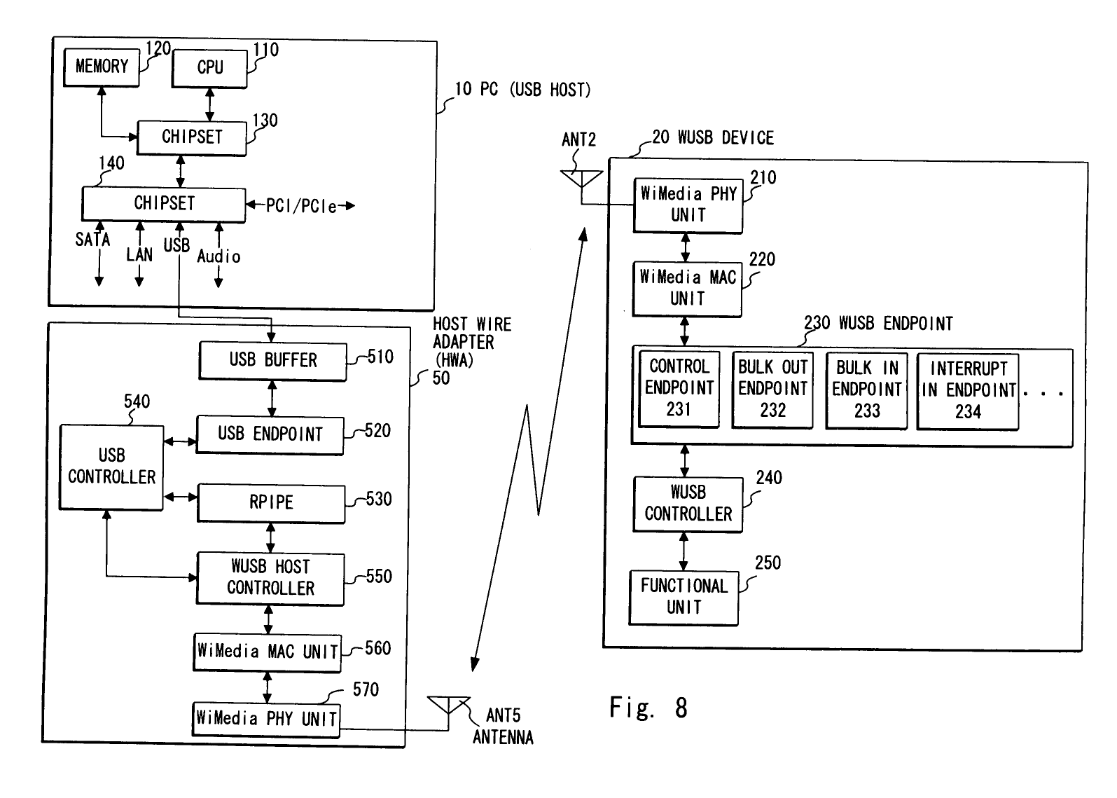

A wireless communication system shown in FIG. 8 is different from the first exemplary embodiment in that a host wire adapter (HWA) 50 is used instead of the WHCI 150 shown in FIG. 1. The HWA 50 is connected to the chipset 140 via a USB protocol. In this wireless communications system, wireless communications are performed between the HWA 50 and the DWA 30.

The HWA 50 is controlled as a USB device by a USB host controller (not shown) in the chipset 140 (namely, the PC 10 functions as a USB host). The HWA 50 includes a USB buffer 510 provided between the PC 10, a USB endpoint 520, a RPIPE 530, a USB controller 540, a WUSB host controller 550, a WiMedia MAC unit 560, and a WiMedia PHY unit 570. The USB controller 540 controls reading out and writing from/to the USB endpoint 520 and the RPIPE 530. The WUSB host controller 550 generates the MMC packet and transfers the combined information packet and the combined packet.

As for a data packet transfer operation in the OUT direction from the HWA 50 to the WUSB device 20, the combined information packet and the combined packet generated by the CPU 110 in the PC 10 are firstly stored in the USB endpoint 520 via the USB buffer 510. The USB controller 540 recognizes that the combined information packet and the combined packet are stored. Then the USB controller 540 reads out the combined information packet and the combined packet stored in the USB endpoint 520 and stores them in the RPIPE 530. At the same time, the USB controller 540 notifies to the WUSB host controller 550 that the combined information packet and the combined packet are stored in the RPIPE 530. As with the USB host controller 152 shown in FIG. 1, the WUSB host controller 550 transmits the combined information packet and the combined packet respectively to the control endpoint 231 and the bulk OUT endpoint 232 in the WUSB device 20. As with the first exemplary embodiment, the WUSB device 20 obtains the original data packets from the combined packet.

On the other hand, as for a data packet transfer operation in the IN direction, in a similar way as the WUSB host controller 152 shown in FIG. 1, the WUSB host controller 550 receives the combined information packet and the combined packet from the WUSB device 20 and stores them in the RPIPE 530. The USB controller 540 recognizes that the combined information packet and the combined packet are stored. Then the USB controller 540 reads out the combined information packet and the combined packet stored in the RPIPE 530 and stores them in the USB endpoint 520, thereby providing the combined information packet and the combined packet to the PC 10 via the USB buffer 510. As with the first exemplary embodiment, the CPU 110 in the PC 10 obtains the original data packets from the combined packet.

As with the abovementioned first exemplary embodiment, the time required to transfer data packets can be largely reduced as compared to the abovementioned related technique and data burst method.

### Fourth Exemplary Embodiment

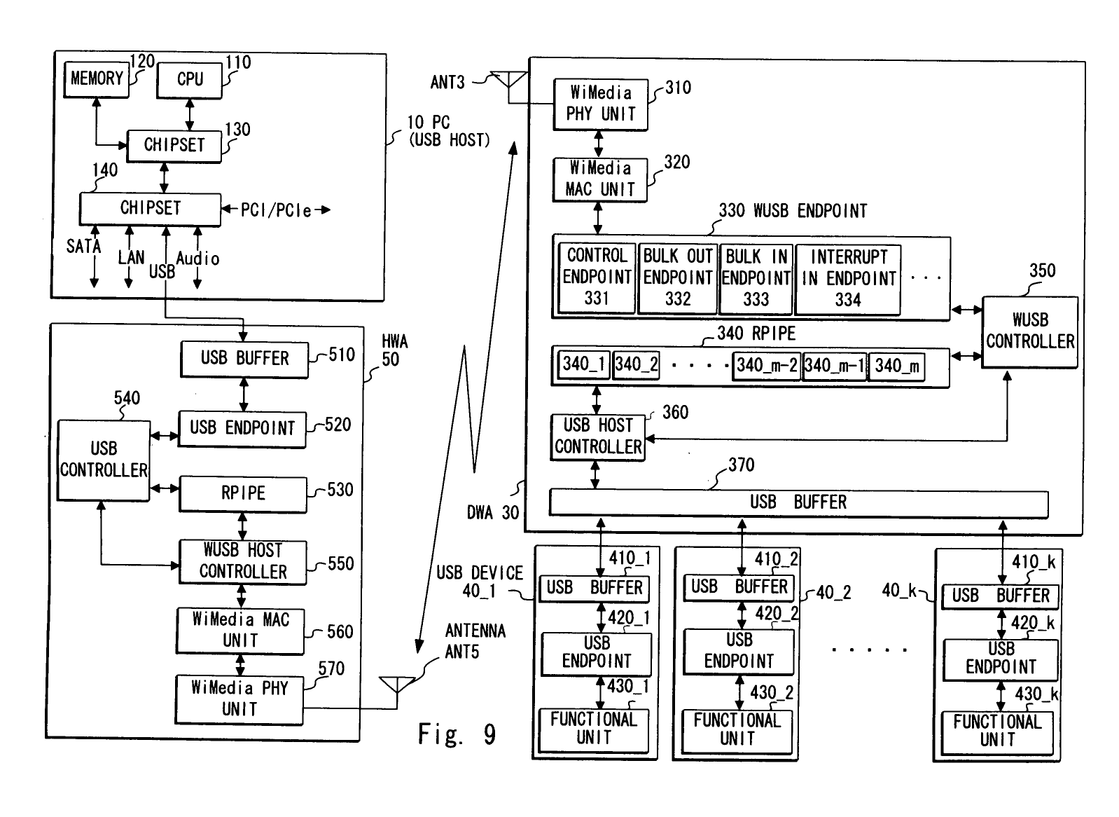

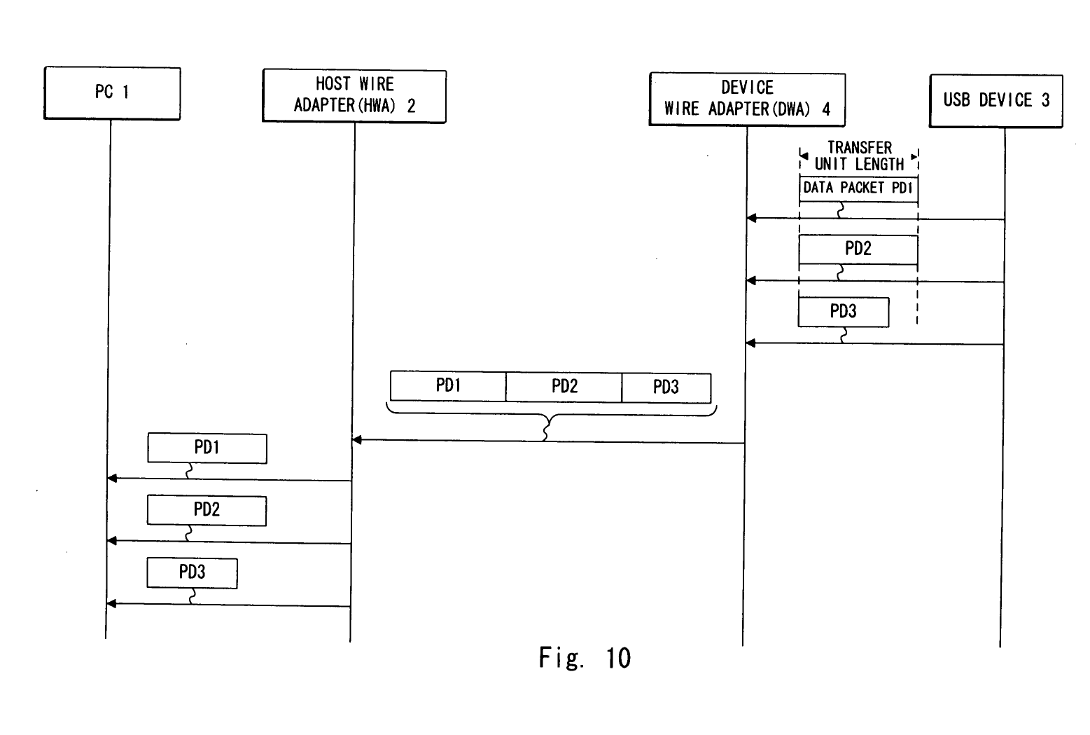

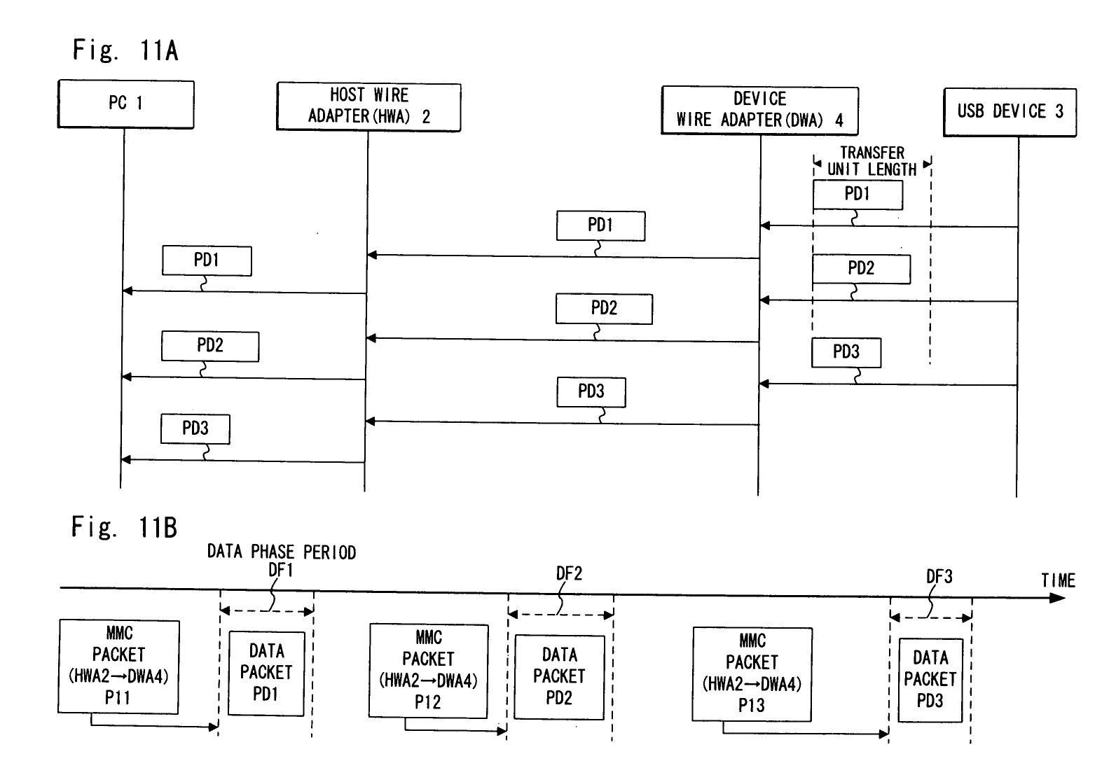

A wireless communication system shown in FIG. 9 is composed of the PC10 and the HWA 50 shown in FIG. 8, and the DWA 30 and the USB device 40 shown in FIG. 5. Wireless communications are performed between the HWA 50 and the DWA 30.

As for the operation, the CPU 110 in the PC 10, the WUSB host controller 550 in the HWA 50, and the DWA 30 execute the processes explained in the second exemplary embodiment. Further, the WUSB host controller 550 also interoperates with the USB controller 540 explained in the third exemplary embodiment.

Accordingly, as with the second exemplary embodiment, even when composing a wireless communication system using a device wire adapter, the data packet transfer time can be largely reduced as compared to the abovementioned related technique and data burst method (especially to FIGS. 12A and 12B).

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

The first to fourth exemplary embodiments can be combined as desirable by one of ordinary skill in the art.

What is claimed is:

1. A wireless communication apparatus comprising:
a combined information packet transmitter that transmits a combined information packet to another wireless communication apparatus, the combined information packet being specified with each packet length of a plurality of packets having a packet length other than a predetermined transfer unit or different packet length; and
a combined packet transmitter that transmits a combined packet to the another wireless communication apparatus, the combined packet being the plurality of packets combined.

2. The wireless communication apparatus according to claim 1, wherein the another wireless communication apparatus is a wireless USB (Universal Serial Bus) device or a device wire adapter connected with a USB device,
the combined information packet transmitter transmits the combined information packet to a first endpoint included in the wireless USB device or the device wire adapter, and
the combined packet transmitter transmits the combined packet to a second endpoint included in the wireless USB device or the device wire adapter.

3. The wireless communication apparatus according to claim 2, wherein the first endpoint is an endpoint for control, and
the second endpoint is an endpoint for receiving data.

4. The wireless communication apparatus according to claim 1, wherein the another wireless communication apparatus is a device wire adapter connected with a USB device, and
the plurality of packets include a packet that requests to transfer data to the USB device.

5. The wireless communication apparatus according to claim 1, wherein the wireless communication apparatus obtains the plurality of packets from a USB device connected to the apparatus itself.

6. The wireless communication apparatus according to claim 5, wherein the combined information packet transmitter includes in the combined information packet a packet length of a packet indicating a data obtained result from the USB device, and
the combined packet transmitter combines the plurality of packets with the packet indicating the data obtained result.

7. A wireless communication apparatus comprising:
a combined packet receiver that receives a combined information packet and a combined packet, the combined information packet being specified with each packet length of a plurality of packets having a packet length other than a predetermined transfer unit or different packet length, and the combined packet being the plurality of packets combined; and
a combined packet divider that divides the combined packet into the plurality of packets based on the combined information packet.

8. The wireless communication apparatus according to claim 7, wherein the another wireless communication apparatus is a wireless USB device or a device wire adapter connected with a USB device, and
the combined packet receiver receives the combined information packet and the combined packet respectively from a first endpoint and a second endpoint included in the wireless USB device or the device wire adapter.

9. The wireless communication apparatus according to claim 8, wherein the first endpoint is an endpoint for control, and
the second endpoint is an endpoint for transmitting data.

10. A method of transferring packets comprising:
transmitting a combined information packet to a wireless communication apparatus, the combined information packet being specified with each packet length of a plurality of packets having a packet length other than a predetermined transfer unit or different packet length; and
transmitting a combined packet to the wireless communication apparatus, the combined packet being the plurality of packets combined.

11. The method according to claim 10, wherein if the wireless communication apparatus is a wireless USB device or a device wire adapter connected with a USB device, the method further comprising:
transmitting the combined information packet to a first endpoint included in the wireless USB device or the device wire adapter; and
transmitting the combined packet to a second endpoint included in the wireless USB device or the device wire adapter.

12. The method according to claim 11, wherein an endpoint for control is used as the first endpoint, and
an endpoint for receiving data is used as the second endpoint.

13. The method according to claim 10, wherein if the wireless communication apparatus is a device wire adapter connected with a USB device, the method further comprising:
including in the plurality of packets a packet requesting to transfer data to the USB device.

14. The method according to claim 10, wherein the plurality of packets are obtained from a USB device.

15. The method according to claim 14, further comprising:
including in the combined information packet a packet length of a packet indicating a data obtained result from the USB device; and
combining the plurality of packets and the packet indicating the data obtained result.

16. A method of transferring packets comprising:
receiving a combined information packet and a combined packet, the combined information packet being specified with each packet length of a plurality of packets having a packet length other than a predetermined transfer unit or different packet length, and the combined packet being the plurality of packets combined; and
dividing the combined packet into the plurality of packets based on the combined information packet.

17. The method according to claim 16, wherein if the wireless communication apparatus is a wireless USB device or a device wire adapter connected with a USB device, the method further comprising:
receiving the combined information packet and the combined packet respectively from a first endpoint and a second endpoint included in the wireless USB device or the device wire adapter.

18. The method according to claim 17, wherein an endpoint for control is used as the first endpoint, and
an endpoint for transmitting data is used as the second endpoint.
